(19) United States
(12) Patent Application Publication
(10) Pub. No.: US 2011/0074954 A1
(43) Pub. Date: Mar. 31, 2011

(54) IMAGE MONITORING SYSTEM FOR VEHICLE

(76) Inventor: SHIEN-MING LIN, Luzhu Township (TW)

(21) Appl. No.: 12/569,413

(22) Filed: Sep. 29, 2009

(51) Int. Cl. H04N 5/28

(52) U.S. Cl. 348/148; 348/E05.061

(57) ABSTRACT

An image monitoring system for vehicles is provided. The system includes plural image sensing modules, one or more hub, a central processing module, and a display module. The images captured by the image sensing modules are respectively digitally processed, compressed, and then transmitted to the hub. The hub integrates the compressed signals and generates an integrated signal. The central processing module is used for decompressing the integrated signal, so as to generate at least one recovered video signal. The at least one recovered video signal can be displayed on the display module. This system can also include a storage module for storing image data.

### BACKGROUND OF THE INVENTION

1. Field of the Invention

The present invention relates to image monitoring systems. In particular, the present invention relates to an image monitoring system integrating multiple cameras.

2. Description of the Prior Art

With the advancement in various consumer electronic products, more and more vehicles are equipped with a small LCD panel in front of the driver's seat. This display panel can display video films, information about the multimedia system, or maps provided by navigation software. Besides these functions, some display panels can also display exterior images captured by cameras assembled at the front or rear parts of the vehicle, so as to assist the driver in knowing conditions in the vicinity of the vehicle.

In present electronic systems for vehicles, cameras assembled at different locations respectively transmit captured images to the central control apparatus and the display panel generally located at the front part of the vehicle. In other words, there is an independent transmission cable connected between each camera and the central control apparatus. For vehicles with limited inner spaces, the more cameras are used, the more troublesome the arrangement of transmission cables is. Correspondingly, the complexity of maintaining this system is also high.

### SUMMARY OF THE INVENTION

To solve the aforementioned problem, the invention provides an image monitoring system that effectively integrates signals with hubs.

The image monitoring system in one embodiment according to the invention includes a plurality of image detecting modules assembled on a vehicle, a hub, a central processing module, and a display module. After being respectively processed and compressed, the video signals captured by the image detecting modules are transmitted to the hub via transmitting interfaces. The hub is used for receiving and integrating the compressed signals to generate an integrated signal. The central processing module is used for decompressing the integrated signal to at least one recovered video signal and providing the at least one recovered video signal to the display module.

By utilizing hubs to integrate signals from plural image detecting modules and other peripheral devices, the number of transmission cables connected to the central control apparatus and the display panel is considerably reduced. The complexity and cost of setting up of the system are both decreased. Further, the complexity of maintaining this system is lowered as well. The image monitoring system according to the invention is especially suitable for vehicles with limited inner spaces.

The advantage and spirit of the invention may be understood by the following recitations together with the appended drawings.

### BRIEF DESCRIPTION OF THE APPENDED DRAWINGS

FIG. 1(A), FIG. 1(B), and FIG. 1(C) illustrate the block diagram of the image monitoring system for vehicles in the first embodiment according to the invention.

FIG. 2 is the block diagram of the image monitoring system for vehicles in the second embodiment according to the invention.

FIG. 3(A) and FIG. 3(B) illustrate the block diagram of the image monitoring system for vehicles in the third embodiment according to the invention.

FIG. 4 is the block diagram of the image monitoring system for vehicles in the fourth embodiment according to the invention.

### DETAILED DESCRIPTION OF THE INVENTION

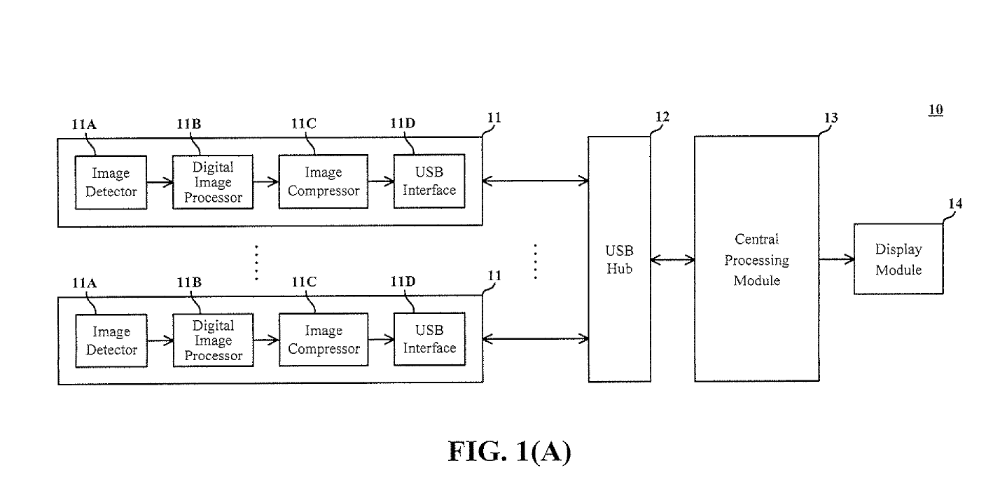

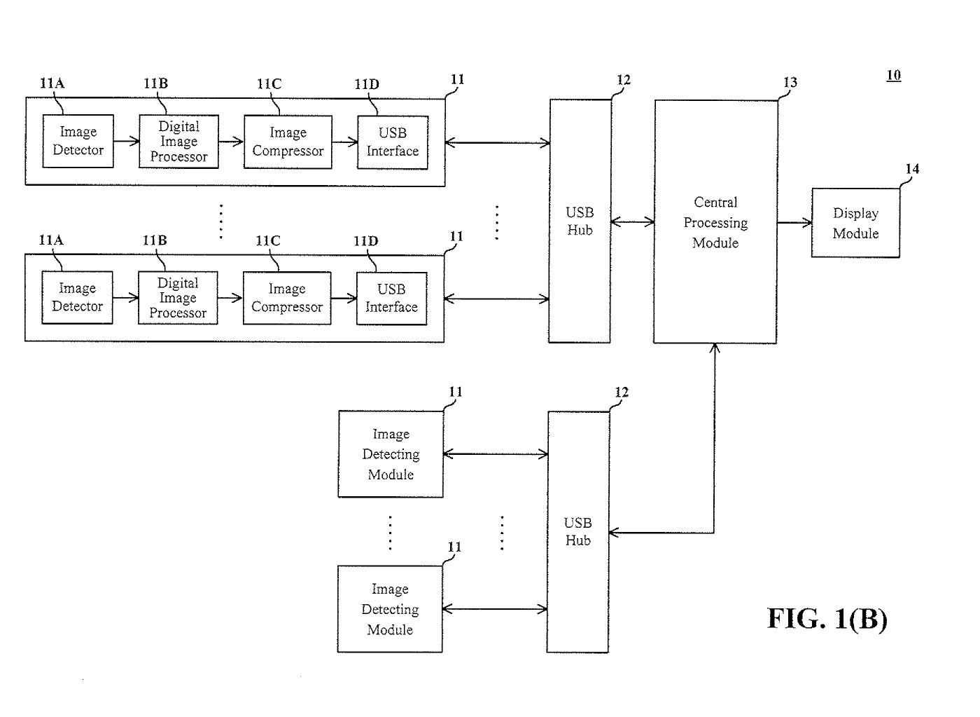

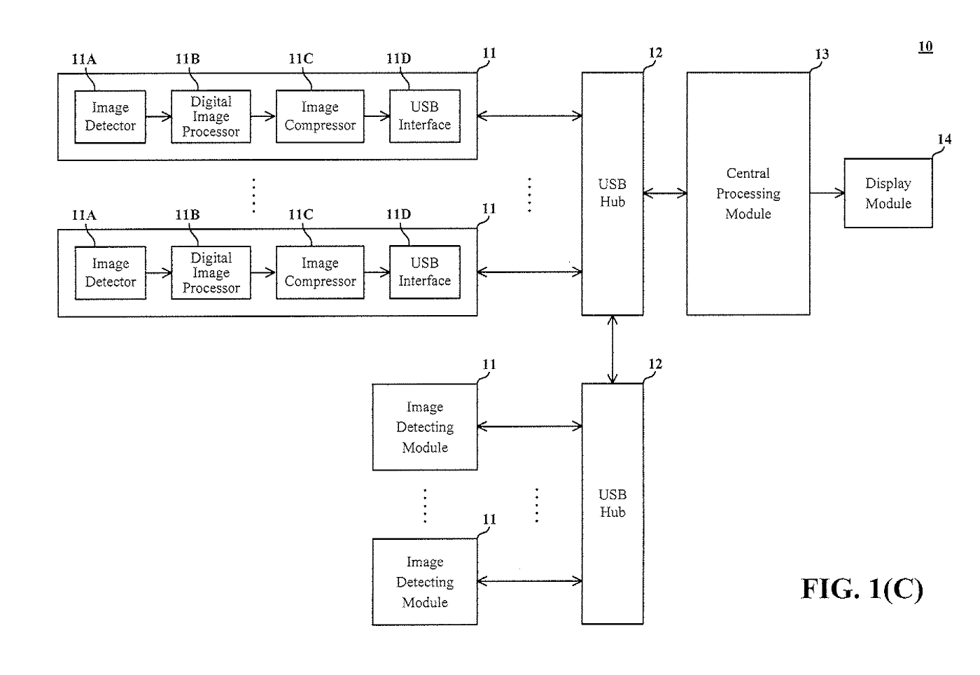

Please refer to FIG. 1(A), which illustrates the block diagram of the image monitoring system for vehicles in one embodiment according to the invention. The image monitoring system 10 includes a plurality of image detecting modules 11 (only two are presented in this figure), a hub 12, a central processing module 13, and a display module 14.

The image detecting modules 11 can be assembled at various locations on the vehicle with high flexibility. For example, image detecting modules 11 disposed at the front or rear regions of the vehicle can be used to observe surroundings out of the vehicle. Taking passenger coaches for instance, the image detecting modules 11 disposed around drivers' seat or passengers' seats can be used to monitor or record the conditions of people inside the car. For boot trunks of passenger coaches or freight cars, the image detecting modules 11 can be used to monitor areas where commodities are placed.

As shown in FIG. 1(A), each of the image detecting modules 11 respectively includes an image detector 11A, a digital image processor 11B, an image compressor 11C, and a transmitting interface 11D. In the following descriptions, the condition that both the transmitting interface 11D and the hub 12 conform to the universal serial bus (USB) standard is taking as an example.

The image detector 11A is used for capturing images of an outer or inner region of the vehicle and generating a video signal. In actual applications, the image detector 11A can be an analog image detector conforming to NTSC or PAL specifications. Alternatively, the image detector 11A can also be a digital image detector including optical lenses and a complementary metal-oxide semiconductor (CMOS) image sensor or a charged coupled device (CCD) image sensor.

The digital image processor 11B electrically connected to the image detector 11A is used for performing a digital image processing procedure on the video signal generated by the image detector 11A and then generates a processed signal. For instance, the digital image processor 11B can perform an automatic exposure process on images or films generated by the image detector 11A, so as to adjust their brightness or contrast. The digital image processor 11B can also improve the color quality of images by processes such as white-balance correction or color correction.

If the image detector 11A is a digital image detector with a CMOS or CCD image sensor, the output signal of the image detector 11A has already been a digital signal. Hence, an analog-to-digital converter between the image detector 11A and the digital image processor 11B is not needed under this condition. Image distortions caused by analog-to-digital conversions can thereby be prevented.

The image compressor 11C is electrically connected to the digital image processor 11B and used for compressing the processed signal provided by the digital image processor 11B, so as to generate a compressed signal. Practically, the image compressor 11C can adopt compression standards such as MPEG4, H.264, MJPEG, etc., but not limited to these examples. Besides, compression standards adopted by image compressors 11C in different image detecting modules 11 do not have to be the same.

The USB interface 11D is used for transmitting the compressed signal to external devices connected to the image detecting module 11. The USB hub 12 is responsible for receiving and integrating the compressed signals from the image detecting modules 11, so as to generate an integrated signal.

According to the invention, the resolution and compression-ratio adopted by the image compressors 11C can be related to transmitting limitations of the USB hub 12. Taking USB 2.0 standard as an example, each USB hub can receive signals from at most four USB devices, and the maximum data amount transmitted in a USB cable is 480 Mb/s. Based on this limitation, the data amount outputted by the image detecting modules 11 and the compression-ratio adopted by the image compressors 11C can be determined.

The central processing module 13 can include a decompressor conforming to MJPEG, MPEG4, or H.264 standards. The central processing module 13 decompresses the integrated signal provided by the USB hub 12 and generates at least one recovered video signal. The recovered video signal is then displayed by the display module 14. In actual applications, the display module 14 can be an LCD or CRT display assembled nearby the driver's seat.

As shown in the embodiment above, by integrating video signals from plural image detecting modules 11 with the USB hub 12, the number of cables connected to the central processing module 13 and the display module 14 can be substantially reduced in the image monitoring system 10 according to the invention. The configuration of transmission cables is accordingly not so complicated. For vehicles having only small inner spaces, this advantage is particularly important.

As shown in FIG. 1(B), the image monitoring system 10 can further include the second group of image detecting modules 11 connected to the central processing module 13 via another USB hub 12. For example, one of the USB hubs 12 can be used for integrating the image detecting modules 11 assembled at the rear part of the vehicle, and the other USB hub 12 can be used for integrating the image detecting modules 11 assembled at the front part of the vehicle. Accordingly, numerous transmission cables originally connected from different locations to the central processing module 13 are simplified to only two transmission cables.

FIG. 1(C) illustrates another exemplary embodiment according to the invention. In this embodiment, one of the two USB hubs 12 is connected to the central processing module 13 via the other USB hub 12. As long as the USB cable can afford the data amount contributed from all the image detecting modules 11, this kind of connection structure is also practicable.

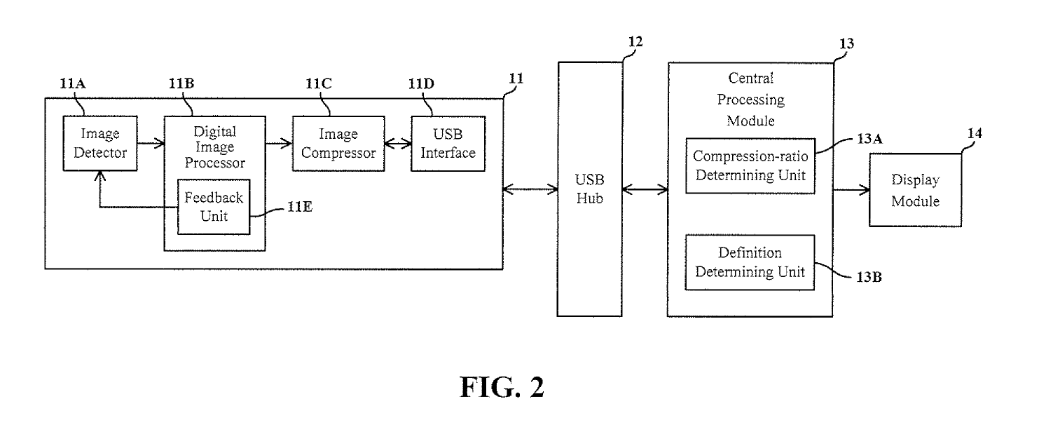

Please refer to FIG. 2, which shows the image monitoring system in another embodiment according to the invention. In this embodiment, the digital image processor 11B further includes a feedback unit 11E. The feedback unit 11E generates a feedback signal for adjusting the image detector 11A based on the processing result of the digital image processing procedure in the digital image processor 11B. This feedback signal can be related to an exposure setting, a white balance setting, a resolution setting, or a color setting of the image detector 11A. For example, if the digital image processor 11B finds the brightness of images captured by the image detector 11A is not enough, the feedback unit 11E can automatically generate a control signal to increase the exposure amount of the image detector 11A.

Besides, the central processing module 13 in this embodiment further includes a compression-ratio determining unit 13A and a resolution determining unit 13B. The two units are used for determining the compression-ratio and resolution of the image detecting modules 11 based on the transmitting limitation of the USB hub 12 and the number of the image detecting modules 11 connected to the USB hub 12.

In other words, when there are fewer image detecting modules 11 connected to the USB hub 12, the compression-ratio determining unit 13A can suggest the image compressors 11C to adopt lower compression-ratio, so as to reduce the image quality loss which is caused by image compression. On the contrary, when there are more image detecting modules 11, the compression-ratio determining unit 13A can suggest the image compressors 11C to adopt higher compression-ratio, so as to reduce the data amount outputted from the image detecting modules 11 and accordingly make the final integrated signal be affordable by the transmission bandwidth of USB cable.

On the other aspect, when there are fewer image detecting modules 11 connected to the USB hub 12, the resolution determining unit 13B can suggest the image detectors 11A to adopt a higher resolution, so as to increase the image quality. On the contrary, when there are more image detecting modules 11, the resolution determining unit 13B can suggest the image detectors 11A to adopt a lower resolution, so as to reduce the data amount outputted from the image detecting modules 11 and accordingly make the integrated signal be affordable by the transmission bandwidth of USB cable.

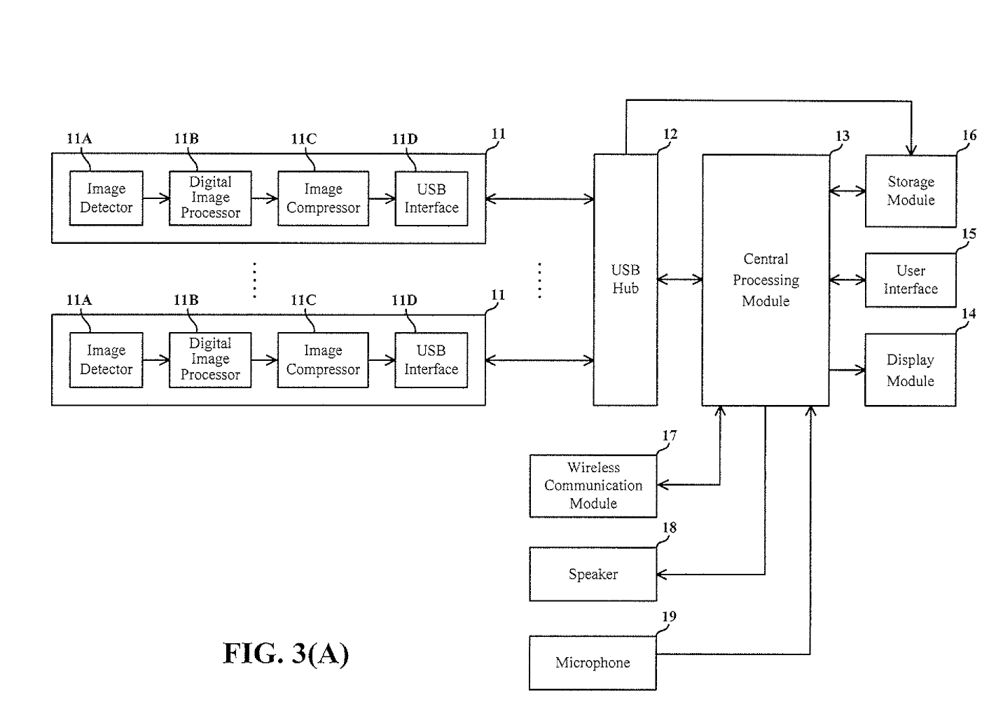

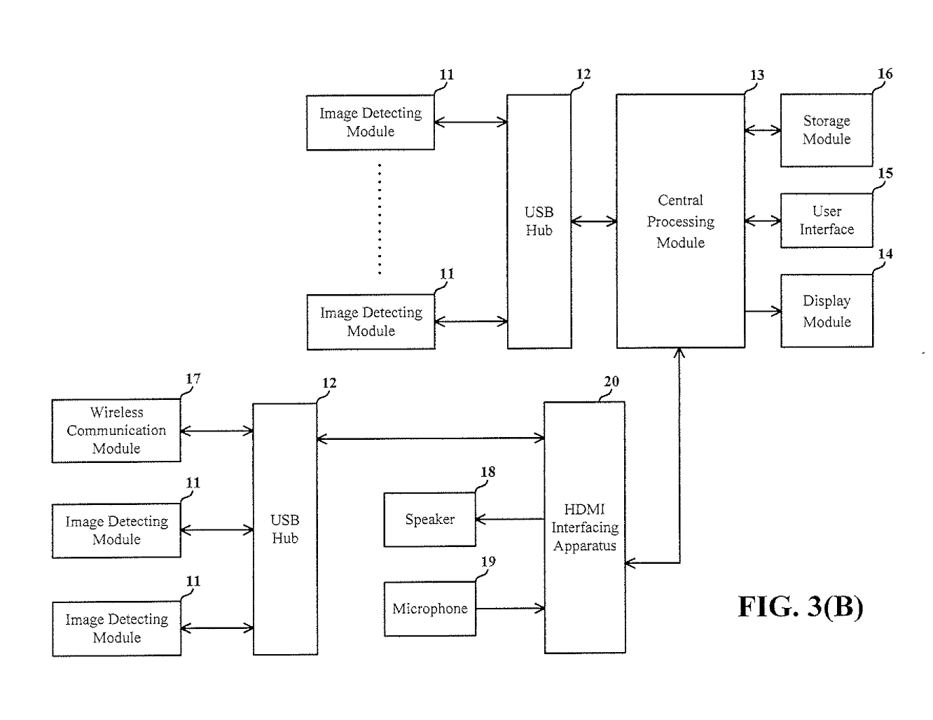

Please refer to FIG. 3(A), which shows the image monitoring system in another embodiment according to the invention. In this embodiment, the image monitoring system further includes a user interface 15, a storage module 16, a wireless communication module 17, a speaker 18, and one or two digital microphone 19.

The user interface 15 can be assembled in a gauge board or on a rear-view mirror of the vehicle. Users can input a user command via this user interface 15. Practically, the user interface 15 can be a touch-control panel integrated with the display module 14. In addition, the user interface 15 can include keyboards or knobs adjacent to the display module 14.

The central processing module 13 can adjust the at least one recovered video signal according to user commands. For example, when the vehicle is moving backward, the driver may want the display module 14 to display images captured by the image detecting modules 11 assembled at the rear part of the vehicle. Via the user interface 15, users can select which captured images are going to be displayed on the display module 14. According to this user command, the central processing module 13 will select the requested ones from the decompressed signals and transmit them to the display module 14. Besides, the user command may also represent that the user wants to enlarge images captured by certain image detecting module 11.

The storage module 16 is electrically connected to the central processing module 13, too. The function of the storage module 16 is storing the integrated signal outputted from the USB hub 12, the recovered video signal generated by the central processing module 13, signals with the same compression format of those outputted from the image compressors 11C, or signals being further compressed by the central processing module 13 with a higher compression-ratio. The signals stored in the storage module 16 are prepared for conditions if users want to review previous images. In actual applications, the storage module 16 can be a hard disk device or a removable memory card.

The wireless communication module 17 can be used for receiving a remote control signal for controlling the central processing module 13 from a remote system. The wireless communication module 17 can also be used for transmitting a monitoring result provided by the central processing module 13 to a remote system. For example, the image monitoring system can be connected with a security system via the wireless communication module 17. If the central processing module 13 or the driver finds something wrong, the wireless communication module 17 can be controlled to transmit a message of asking for help to the security system. Further, the remote security system can also receive images captured by the image detecting modules 11 via the wireless communication module 17.

Moreover, the wireless communication module 17 can be used for receiving newer firmware for the central processing module 13 from a remote system. By doing this, the operations and functions of the central processing module 13 can be updated or modified. In actual applications, the wireless communication module 17 can conform to one or more wireless communication standards.

The speaker 18 is used for receiving an audio signal from the central processing module 13 and broadcasting the audio signal. This audio signal may be a warning message generated by the central processing module 13 based on the integrated signal. The central processing module 13 might generates the warning message, for instance, to warm the driver that the vehicle is too close to certain exterior objects. The microphone 19 is used for receiving an external voice signal, such as a voice command of the user, and transmitting the external voice signal to the central processing module 13.

As shown in FIG. 3(B), speaker 18 and microphone 19 can be connected to the central processing module 13 via a high definition multimedia interface (HDMI) apparatus 20. The wireless communication module 17 can also be connected to the central processing module 13 via a certain USB hub 12 and the HDMI interfacing apparatus 20. At the present time, the most commonly used HDMI interface has nineteen pins. In the image monitoring system according to the invention, two of these pins can be utilizes for transmitting USB signals to the central processing module 13.

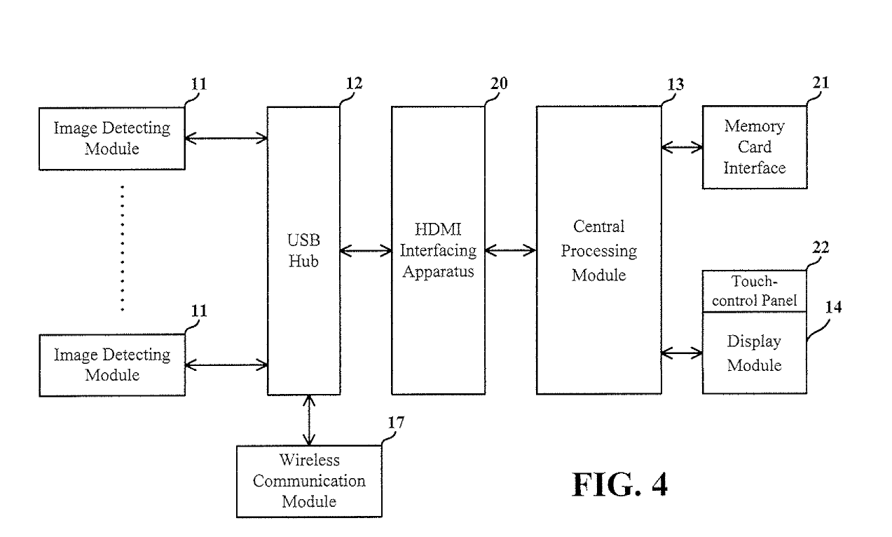

Please refer to FIG. 4, which shows the image monitoring system in another embodiment according to the invention. This image monitoring system includes a plurality of image detecting modules 11, a wireless communication module 17, a USB hub 12, an HDMI interfacing apparatus 20, a central processing module 13, a display module 14, and a control panel with a memory card interface 21 and a touch-control panel 22. This control panel can be assembled on the gauge board or on a rear-view mirror.

The memory card interface 21 is used for assisting the central processing module 13 in connecting to a removable memory card, such as a secure digital (SD) card, a compact flash (CF) card, or memory cards of other formats. Thereby, the user can copy images captured by the image detecting modules 11 on the vehicle to other personal computer systems.

In this embodiment, the touch-control panel 22 is integrated with the display module 14. Users are capable of inputting user commands for controlling the central processing module 13 via this touch-control panel 22. Besides, if the display module 14 can show number keys, the image monitoring system can further utilize the wireless communication module 17 mentioned above to provide the service of making phone calls in the vehicle by receiving phone numbers via the touch-control panel 22.

As described above, by utilizing hubs to integrate signals from plural image detecting modules and other peripheral devices, the number of transmission cables connected to the central control apparatus and the display panel is considerably reduced. The complexity and cost of setting up of the system are both decreased. Further, the complexity of maintaining this system is lowered as well. It can be seen that the image monitoring system according to the invention is especially suitable for vehicles with limited inner spaces. Similarly, for apartment buildings, offices, or public places where a higher space utility is required, the image monitoring system according to the invention can also be used.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An image monitoring system for a vehicle, comprising:
a plurality of image detecting modules assembled on the vehicle, each of the image detecting modules comprising:
an image detector, for capturing images of an outer region or an inner region of the vehicle and generating a video signal;
a digital image processor, electrically connected to the image detector, for performing a digital image processing procedure on the video signal to generate a processed signal;
an image compressor, electrically connected to the digital image processor, for compressing the processed signal to generate a compressed signal; and
a transmitting interface, electrically connected to the image compressor, for transmitting the compressed signal;
a hub, electrically connected to the image detecting modules, for receiving and integrating the compressed signals to generate an integrated signal;
a central processing module, electrically connected to the hub, for receiving the integrated signal and decompressing the integrated signal to at least one recovered video signal; and
a display module, electrically connected to the central processing module, for receiving and displaying the at least one recovered video signal.

2. The image monitoring system of claim 1, wherein the transmitting interface and the hub conform to a universal serial bus (USB) standard.

3. The image monitoring system of claim 1, wherein the digital image processor further comprises a feedback unit, the feedback unit generates a feedback signal for adjusting the image detector based on a processing result of the digital image processing procedure.

4. The image monitoring system of claim 3, wherein the feedback signal is related to an exposure setting, a white balance setting, a resolution setting, or a color setting of the image detector.

5. The image monitoring system of claim 1, wherein a compression-ratio adopted by the image compressor or a resolution adopted by the image detector are relative to a transmitting bandwidth limitation of the hub.

6. The image monitoring system of claim 5, wherein the central processing module further comprises a compression-ratio determining unit, based on the transmitting limitation of the hub and the number of the image detecting modules, the compression-ratio determining unit determines the compression-ratio and provides the compression-ratio to the image detecting modules.

7. The image monitoring system of claim 5, wherein the central processing module further comprises a resolution determining unit, based on the transmitting bandwidth limitation of the hub and the number of the image detecting modules, the resolution determining unit determines the resolution and provides the resolution to the image detecting modules.

8. The image monitoring system of claim 1, wherein the image compressor compresses the processed signal according to an MPEG4 standard, an H.264 standard, or an MJPEG standard, and the central processing module comprises a decompressor conforming to the same standard.

9. The image monitoring system of claim 1, further comprising:
a user interface electrically connected to the central processing module, a user being capable of inputting a user command to the central processing module via the user interface, the central processing module adjusting the at least one recovered video signal based on the user command.

10. The image monitoring system of claim 9, wherein the user command represents the at least one recovered video signal is related to which image detecting modules among the image detecting modules.

11. The image monitoring system of claim 1, further comprising:
a storage module, electrically connected to the central processing module, for storing the integrated signal or the recovered video signal.

12. The image monitoring system of claim 1, further comprising:
a wireless communication module, electrically connected to the central processing module, for receiving a remote control signal for controlling the central processing module from a remote system.

13. The image monitoring system of claim 12, wherein the wireless communication module is also used for transmitting a monitoring result provided by the central processing module to the remote system.

14. The image monitoring system of claim 1, further comprising:
a speaker, electrically connected to the central processing module, for receiving an audio signal from the central processing module and broadcasting the audio signal, the audio signal being a warning message generated by the central processing module based on the integrated signal.

15. The image monitoring system of claim 1, further comprising:
a microphone, electrically connected to the central processing module, for receiving an external voice signal and transmitting the external voice signal to the central processing module.

16. The image monitoring system of claim 1, wherein the image detector comprises a complementary metal-oxide semiconductor (CMOS) image sensor or a charged coupled device (CCD) image sensor.

17. An image monitoring system for a vehicle, comprising:
a plurality of image detecting modules assembled on the vehicle, each of the image detecting modules comprising:
an image detector, for capturing images of an outer region or an inner region of the vehicle and generating a video signal;
a digital image processor, electrically connected to the image detector, for performing a digital image processing procedure on the video signal to generate a processed signal;
an image compressor, electrically connected to the digital image processor, for compressing the processed signal to generate a compressed signal; and
a transmitting interface, electrically connected to the image compressor, for transmitting the compressed signal;
a wireless communication module, for receiving or transmitting a wireless communication signal;
a hub, electrically connected to the image detecting modules and the wireless communication module, for receiving and integrating the compressed signals with the wireless communication signal to generate an integrated signal;
a high definition multimedia interface (HDMI) interfacing apparatus, electrically connected to the hub, for receiving the integrated signal from the hub;
a central processing module, electrically connected to the interfacing apparatus, for receiving the integrated signal and decompressing the integrated signal to at least one recovered video signal; and
a display module, electrically connected to the central processing module, for receiving and displaying the at least one recovered video signal.

18. The image monitoring system of claim 17, further comprising a control panel assembled in a gauge board or on a rear-view mirror, the control panel being electrically connected to the central processing module and comprising:
a touch-control panel integrated with the display module, a user being capable of inputting a user command for controlling the central processing module via the touch-control panel; and
a memory card interface for assisting the central processing module in connecting to a removable memory card, the central processing module being capable of storing the integrated signal or the recovered video signal into the removable memory card.

19. An image monitoring system, comprising:
a plurality of image detecting modules, each of the image detecting modules comprising:
an image detector, for capturing images of an adjacent region and generating a video signal;
a digital image processor, electrically connected to the image detector, for performing a digital image processing procedure on the video signal to generate a processed signal;
an image compressor, electrically connected to the digital image processor, for compressing the processed signal to generate a compressed signal; and
a transmitting interface, electrically connected to the image compressor, for transmitting the compressed signal;
a hub, electrically connected to the image detecting modules, for receiving and integrating the compressed signals to generate an integrated signal;
a central processing module, electrically connected to the hub, for receiving the integrated signal and decompressing the integrated signal to at least one recovered video signal; and
a display module, electrically connected to the central processing module, for receiving and displaying the at least one recovered video signal.

20. The image monitoring system of claim 19, further comprising:
a wireless communication module, electrically connected to the hub, for receiving firmware update data for the central processing module from a remote system; and
a storage module, electrically connected to the central processing module, for storing the integrated signal or the recovered video signal.
